(19) United States
(12) Patent Application Publication
(10) Pub. No.: US 2007/0282471 A1
(43) Pub. Date: Dec. 6, 2007

(54) Bluetooth audio chip with multiple input/output sources

(75) Inventors: Chung-I Lee, Hsinchu (TW); Sheng-Ming Chang, Hsinchu (TW); Shyh-Ming Huang, Hsinchu (TW); Albert Chen, Hsinchu (TW)

Correspondence Address: BIRCH STEWART KOLASCH & BIRCH, PO BOX 747, FALLS CHURCH, VA, 22040-0747, US

(73) Assignee: Integrated System Solution Corp.

(21) Appl. No.: 11/444,477

(22) Filed: Jun. 1, 2006

(51) Int. Cl. G06F 17/00

(52) U.S. Cl. 700/94

(57) ABSTRACT

A Bluetooth audio chip with multiple input/output sources is implemented on a monolithic integrated circuit. The Bluetooth audio chip includes a Bluetooth Baseband/RF module, an encode/decode module, a stereo ADC/DAC codec module, a USB module, a UART module, and a flash memory. Each one of the modules receives/transmits one kind of audio source, thus the Bluetooth audio chip has deeply embedded with multiple input/output sources. The Bluetooth audio chip is used in a diversity of applications to reduce the cost and time comparing to one purpose chip for just only one specific application.

### BACKGROUND OF THE INVENTION

1. Field of the Invention

The present invention generally relates to a Bluetooth audio chip, and more particularly relates to a Bluetooth audio chip with multiple input/output sources.

2. Description of the Prior Art

In 1998, the Bluetooth wireless technology was under development, the Bluetooth Special Interest Group (SIG) has jointly announced the Bluetooth 1.0 specifications for vendors to follow. So far, many companies have supported the Bluetooth plan for establishing the connecting standard, system and protocol for mobile devices. After the Bluetooth 1.0 specifications are stroke, the global manufactures may design any product embedded with Bluetooth technology, and proceed with the various certifications and tests of Bluetooth compatibility for their own products. The Bluetooth plan makes communication and IT industries join together to develop the technology of short-range radio frequency communication as a transferring tool for 3C consumer products.

The purpose of the Bluetooth plan is to eliminate the restriction resulting in different connectors and standards within electronic and computing devices. Particularly, the Bluetooth technology is an open platform for any person or group, the devices with Bluetooth technology may communicate with each other freely and easily. It is used in many different circumstances including, for example, communication between PCs, from PCs to hand held computers, from mobile telephones to PCs, and from mobile telephone handsets to ear pieces.

For various end-user products, such as PC, notebook, PDA, fax machine and printer, they can connect together if they are equipped with Bluetooth module, and the function of sharing data makes Bluetooth technology mature. Besides, when Bluetooth is used as a communication method, it also combines with the cell phone, iPod, GPS, and so on, to exploit the new application territory. The momentum of the rapid growth power comes from the industry environment and, the energy is fed back to design more interesting products.

Currently, the Bluetooth audio chip is only designed for the transportation protocol in end-user devices, it means the chip in some kind of device has just one wire communication circuit and one wireless Bluetooth circuit. When manufacturers want to apply various digital home appliances, they must design various chips for different IT products or personal electronic devices. Furthermore, in some situation, like transferring stereo music through wireless communication, the source point and the end point must have different Bluetooth modules, the Bluetooth module in the source point is a Bluetooth transmitter and the end point is a Bluetooth stereo earphone which has audio output for the user to hear the sound or music transmitted from the source point. But until now, the Bluetooth chip being developed has just one function for data transmitting in the source point or for receiving data in the end point, causing two unlike Bluetooth chips for two different points, thus the developing time and cost are increased when a new appliance is needed.

There is a wide range of potential markets such as cell phones, laptop computers, PDAs, headphones, keyboards, and digital cameras, and it is desirable to come up with one design that can address all these markets and still maintain a small chip size.

### SUMMARY OF THE INVENTION

In order to solve the problems mentioned above, the present invention provides a Bluetooth audio chip having multiple audio input/output sources. The Bluetooth audio chip integrates different circuit modules (IC) to implement multiple input/output functions for a great diversity of products to reduce the design cost and shorten the developing time.

One of the objectives of the present invention is to provide a Bluetooth audio chip having multiple audio input/output sources, which integrates a plurality of modules into a unitary one and has small size and high spatial efficiency. Especially, using one single IC chip to provide various transmitting and receiving functions.

To achieve the aforementioned objectives, the present invention proposes a Bluetooth audio chip with multiple input/output sources, including: a memory controller module controlling the digital data transferring in the Bluetooth audio chip; a Bluetooth RF (radio frequency) module receiving and transmitting Bluetooth audio packets; a Bluetooth Baseband module coupled to the memory controller module and the Bluetooth RF module, the Bluetooth Baseband module receiving, transmitting the digital data, or transforming the digital data into the Bluetooth audio packets; an encoder/decoder module coupled to the memory controller module, and encoding/decoding the digital data; an internal memory coupled to the memory controller module, and temporarily storing the decoded or encoded digital data; a USB module coupled to the memory controller module, and controlling the receiving and transmitting of digital audio data from/to a USB port; and a stereo ADC/DAC codec module coupled to the memory controller module, and receiving analog signals from an audio port and transforming the digital audio data into the analog audio sound.

Accordingly, one embodiment of the present invention provides a Bluetooth audio chip, which is implemented in a monolithic circuit, including: a memory controller module controlling the digital data transferring in the Bluetooth audio chip; a Bluetooth RF (radio frequency) module receiving and transmitting Bluetooth audio packets; a Bluetooth Baseband module coupled to the memory controller module and the Bluetooth RF module, the Bluetooth Baseband module reading the audio data from the memory controller module and transforming the audio data into Bluetooth audio packets transferred to the Bluetooth RF module, or receiving the Bluetooth audio packets from the Bluetooth RF module and transforming the Bluetooth audio packets into the audio data transferred to the memory controller module; an encoder/decoder module coupled to the memory controller module, and encoding/decoding the audio data in the memory controller module; an internal memory coupled to the memory controller module, and storing the Bluetooth audio data from the memory controller module; a UART module coupled to the memory controller module, the UART module receiving audio data from a UART port and transforming the audio data into the Bluetooth audio data to transfer to the memory controller module, or receiving the Bluetooth audio data from the memory controller module and transforming the Bluetooth audio data into the audio data to transfer to the UART port; and a stereo ADC/DAC codec coupled to the memory controller module, and receiving analog signals from an audio port and transforming the analog signals into digital audio data transferred to the memory controller module, or transforming the digital audio data into the analog signals transferred from the memory controller module.

Furthermore, another embodiment of the present invention provides a Bluetooth audio chip with multiple input/output sources, including: a memory controller module controlling the digital data transferring in the Bluetooth audio chip; a Bluetooth RF (radio frequency) module receiving and transmitting Bluetooth audio packets; a Bluetooth Baseband module coupled to the memory controller module and the Bluetooth RF module, and reading the audio data from the memory controller module and transforming the audio data into Bluetooth audio packets transferred to the Bluetooth RF module, or receiving the Bluetooth audio packets from the Bluetooth RF module and transforming the Bluetooth audio packets into the audio data transfer to the memory controller module; an encoder/decoder module coupled to the memory controller module, and encoding the audio data in the memory controller module, or decoding the Bluetooth audio packets; an internal memory coupled to the memory controller module, and storing the digital audio data transferred from the memory controller module; a USB module coupled to the memory controller module, and controlling the receiving and transmitting of the digital audio data from/to a USB port; a UART module coupled to the memory controller module, and receiving and transmitting digital audio data from/to a UART port; and a stereo ADC/DAC codec coupled to the memory controller module, and receiving analog signals from an audio port and transforming the analog signals into digital audio data transferred to the memory controller module, or transforming the digital audio data to the analog audio sound transferred from the memory controller module.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is the functional diagram of a Bluetooth audio chip having multiple audio input/output sources according to one embodiment of the present invention;

FIG. 2 is the functional diagram of a Bluetooth audio chip having multiple audio input/output sources according to another embodiment of the present invention; and

FIG. 3 is the functional diagram of a Bluetooth audio chip having multiple audio input/output sources according to another embodiment of the present invention.

### DESCRIPTION OF THE PREFERRED EMBODIMENT

The present invention discloses a Bluetooth audio chip with multiple input/output sources, which is implemented on a monolithic integrated circuit.

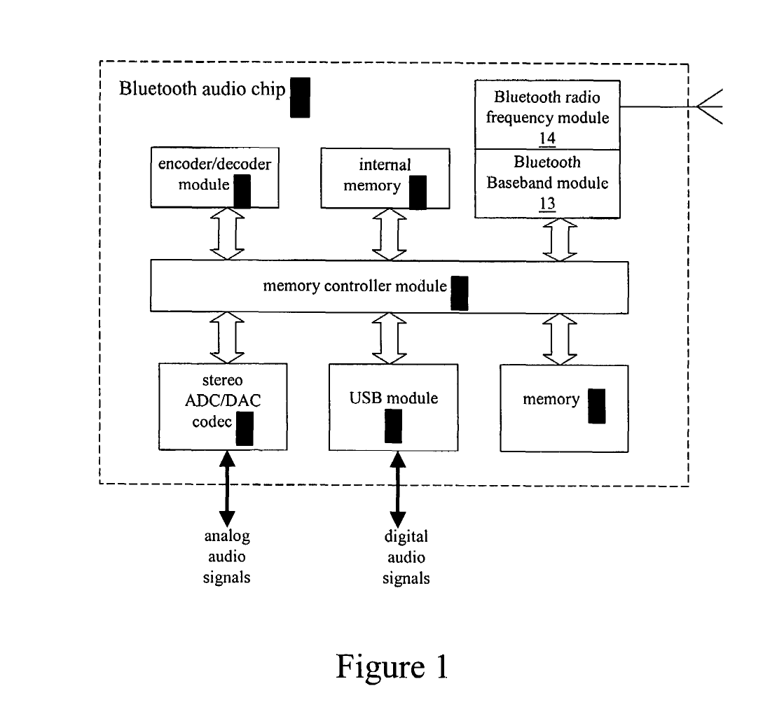

FIG. 1 illustrates the functional diagram of a Bluetooth audio chip having multiple audio input/output sources according to one embodiment of the present invention. The Bluetooth audio chip 10 is implemented in a monolithic circuit, including: a memory controller module 15 controlling the digital data transferring in the Bluetooth audio chip 10; a Bluetooth radio frequency (RF) module 14 receiving and transmitting Bluetooth audio packets; a Bluetooth Baseband module 13 coupled to the memory controller module 15 and the Bluetooth RF module 14, and receiving, transmitting the digital data and transforming them into Bluetooth audio packets; an encoder/decoder module 11 coupled to the memory controller module 15 and encoding/decoding the digital data; an internal memory 12 coupled to the memory controller module 15 and temporarily storing the digital data which are decoded or encoded; a USB module 17 coupled to the memory controller module 15 and controlling the receiving and transmitting of the digital audio data from/to a USB port; and a stereo ADC/DAC codec 16 coupled to the memory controller module 15, and receiving analog audio signals from an audio port and transforming the analog audio signals into digital audio data, or receiving digital audio data from the memory controller module 15 and transforming the digital audio data into analog audio signals to the audio port. The internal memory 12 may be a RAM memory.

In addition, the Bluetooth audio chip 10 includes a memory 19 coupled to the memory controller module 15 for storing digital data, such as MP3 files, and the memory may be a flash memory.

Accordingly, The Bluetooth audio chip 10 may apply to a diversity of end products, for instance the stereo ADC/DAC codec 16 working with the Bluetooth RF module 14, the Bluetooth Baseband module 13 and encoder/decoder module 11 will receive Bluetooth audio packets from the Bluetooth transmitter, and transform the Bluetooth audio packets into audio signals to a speaker or an earphone through an audio output port. Corresponsively, the Bluetooth audio chip 10 may receive audio signals from the devices with audio output ports, and transform audio signals into Bluetooth audio packets which are transmitted to another Bluetooth device through the Bluetooth Baseband module 13 and the Bluetooth RF module 14. In addition, the Bluetooth audio chip 10 may use the USB module 17 to connect to a USB port in another device, thus establishing the wireless communication capability for that device. The present invention having multiple audio inputs/outputs can be applied to various kinds of products, and it doesn't have the limitation that one chip can just have only one function.

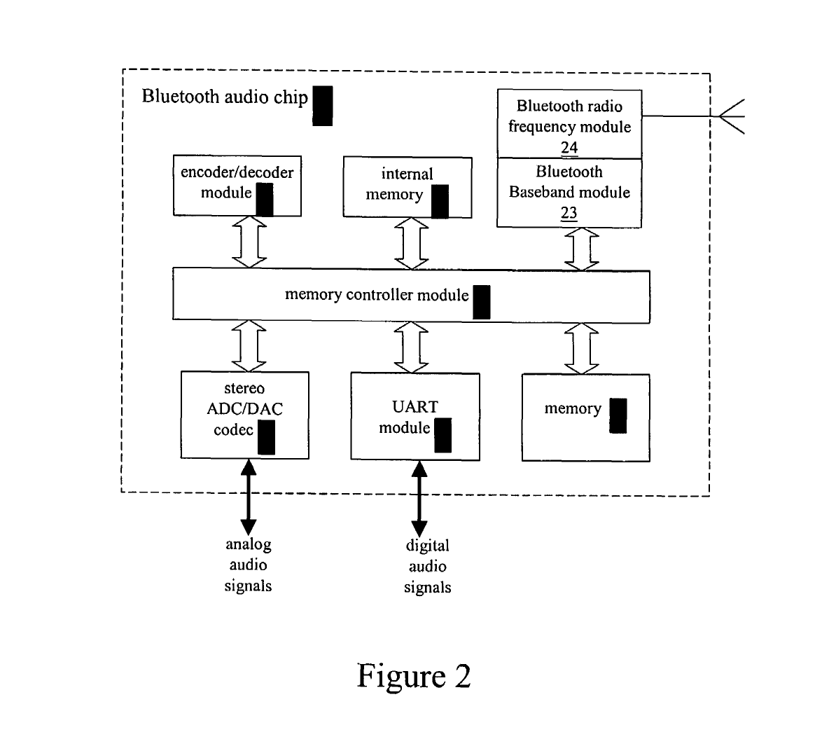

FIG. 2 illustrates the functional diagram of A Bluetooth audio chip having multiple audio input/output sources according to another embodiment of the present invention. The Bluetooth audio chip 20 is implemented in a monolithic circuit, including: a memory controller module 25 controlling the digital data transfer in the Bluetooth audio chip 20; a Bluetooth radio frequency (RF) module 24 receiving and transmitting Bluetooth audio packets; a Bluetooth Baseband module 23 coupled to the memory controller module 25 and the Bluetooth RF module 24, the Bluetooth Baseband module 23 reading the audio data transferred from the memory controller module 25 and transforming the audio data into Bluetooth audio packets to transfer to the Bluetooth RF module 24 or receiving the Bluetooth audio packets from the Bluetooth RF module 24 and transforming the Bluetooth audio packets into audio data to transfer to the memory controller module 25; an encoder/decoder module 21 coupled to the memory controller module 25 and encoding/decoding audio data in the memory controller module 25; an internal memory 22 coupled to the memory controller module 25 and storing the Bluetooth audio data transferred from the memory controller module 25; a UART module 28 coupled to the memory controller module 25, and receiving audio data from a UART port and transforming audio data into Bluetooth audio data to transfer to the memory controller module 25, or receiving the Bluetooth audio data from the memory controller module 25 and transforming the Bluetooth audio data into audio data to transfer to the UART port ; and a stereo ADC/DAC codec 26 coupled to the memory controller module 25, and receiving analog signals from an audio port and transforming the analog signals into digital audio data to transfer to the memory controller module 25, or transforming the digital audio data into the analog signals from the memory controller module 25.

In addition, The Bluetooth audio chip further including a memory coupled to the memory controller module 25 for storing the digital data, such as MP3 files, and the memory may be a flash memory.

Accordingly, The Bluetooth audio chip 20 may apply to a diversity of end products. For instance, the UART module 28 working with the Bluetooth RF module 24 and the Bluetooth Baseband module 23 will receive Bluetooth audio packets from the Bluetooth transmitter, and transform Bluetooth audio packets into audio signals to a PDA or a cellphone through an audio output port. Corresponsively, the Bluetooth audio chip 20 may receive audio signals from the devices with audio output ports, and transform audio signals into Bluetooth audio packets which are transmitted to another Bluetooth device through the Bluetooth Baseband module 23 and the Bluetooth RF module 24. In addition, the stereo ADC/DAC codec 26 working with the Bluetooth RF module 24, the Bluetooth Baseband module 23 and encoder/decoder module 21 will receive Bluetooth audio packets from the Bluetooth transmitter, and transform Bluetooth audio packets into audio signals to a speaker or an earphone through an audio output port. Corresponsively, the Bluetooth audio chip 20 may receive audio signals from the devices with audio output ports, and transform audio signals into Bluetooth audio packets which are transmitted to another Bluetooth device through the Bluetooth Baseband module 23 and the Bluetooth RF module 24.

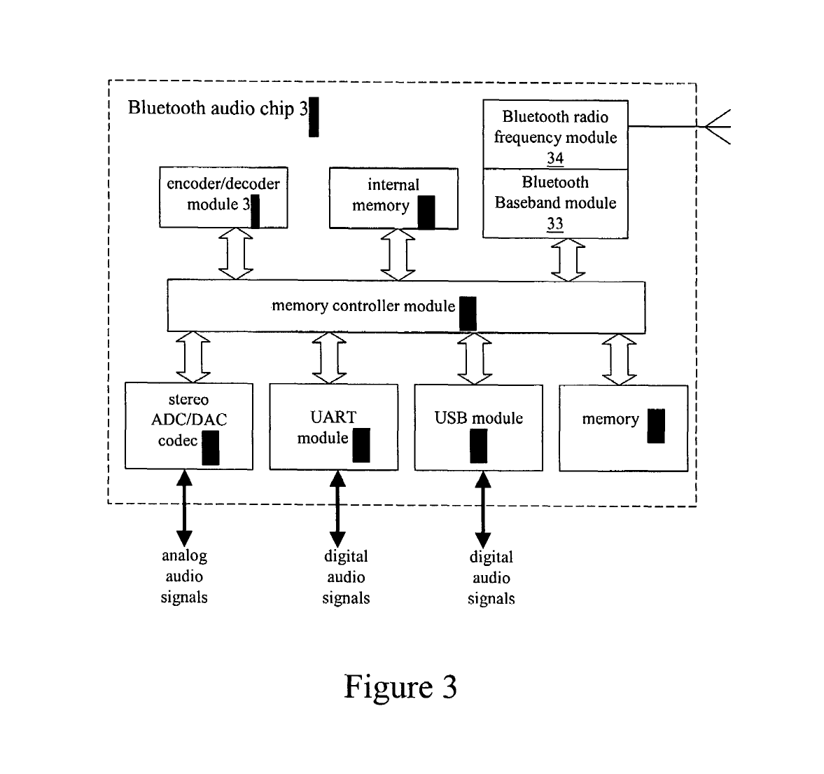

FIG. 3 illustrates the functional diagram of A Bluetooth audio chip having multiple audio input/output sources according to another embodiment of the present invention. A Bluetooth audio chip 30 is implemented in a monolithic circuit, including: a memory controller module 35 controlling the digital data transferring in the Bluetooth audio chip 30; a Bluetooth radio frequency (RF) module 34 receiving and transmitting Bluetooth audio packets; a Bluetooth Baseband module 33 coupled to the memory controller module 35 and the Bluetooth RF module 34, wherein the Bluetooth Baseband module 33 reads the audio data from the memory controller module 35 and transforming the audio data into Bluetooth audio packets to transfer to the Bluetooth RF module 34, or receives the Bluetooth audio packets from the Bluetooth RF module 34 and transforms the Bluetooth audio packets into the audio data to transfer to the memory controller module 35; an encoder/decoder module 31 coupled to the memory controller module 35 and encoding the audio data or decoding the Bluetooth audio packets in the memory controller module 35; an internal memory 32 coupled to the memory controller module 35, and storing the digital audio data transferred from the memory controller module 35; a USB module 37 coupled to the memory controller module 35, and controlling the receiving and transmitting of the digital audio data from/to a USB port; a UART module 38 coupled to the memory controller module 35, wherein the UART module 38 receives and transmits digital audio data from/to a UART port; and a stereo ADC/DAC codec 36 coupled to the memory controller module 35, and receiving analog signals from an audio port and transforming the analog signals into digital audio data transferred to the memory controller module 35, or transforming the digital audio data into the analog audio sound from the memory controller module 35.

In addition, the Bluetooth audio chip includes a memory coupled to the memory controller module 35 for storing the digital data, such as MP3 files, and the memory may be a flash memory.

Accordingly, the stereo ADC/DAC codec 36 working with encoder/decoder module 31, the Bluetooth RF module 34 and the Bluetooth Baseband module 33 will receive Bluetooth audio packets from the Bluetooth transmitter, and transform Bluetooth audio packets into audio signals to a speaker or an earphone through an audio output port. Corresponsively, the Bluetooth audio chip 30 may receive audio signals from the devices with audio output ports, and transform audio signals into Bluetooth audio packets which are transmitted to another Bluetooth device through the Bluetooth Baseband module 33 and the Bluetooth RF module 34. In addition, UART module 38 working with the Bluetooth RF module 34, the Bluetooth Baseband module 33, and encoder/decoder module 31 will receive Bluetooth audio packets from the Bluetooth transmitter, and transform Bluetooth audio packets into audio signals to a PDA or a cellphone through an audio output port. Corresponsively, the Bluetooth audio chip 30 may receive audio signals from the devices with audio output ports, and transform audio signals into Bluetooth audio packets which are transmitted to another Bluetooth device through the Bluetooth Baseband module 33 and the Bluetooth RF module 34. Furthermore, the Bluetooth audio chip 30 may use the USB module 37 to connect to a USB port in another device, thus establishing the wireless communication capability for that device.

Accordingly, the present invention provides a multiple audio inputs/outputs chip to apply in various kinds of products, which can use the same chip. The Bluetooth audio chip integrated with many audio inputs and outputs module has broad applications, thus providing the IC manufacturers to use one chip processes to reduce the developing cost and time. The downstream manufacturers can use the same chip for any Bluetooth related product, such as Bluetooth headset, Bluetooth music transmitter, Bluetooth speaker, Bluetooth audio recorder, and so on.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A Bluetooth audio chip with multiple input/output sources, which is implemented in a monolithic circuit, comprising:
a memory controller module controlling the digital data transferring in said Bluetooth audio chip;
a Bluetooth RF (radio frequency) module receiving and transmitting Bluetooth audio packets;
a Bluetooth Baseband module coupled to said memory controller module and said Bluetooth RF module, said Bluetooth Baseband module receiving, transmitting said digital data, or transforming said digital data into said Bluetooth audio packets;
an encoder/decoder module coupled to said memory controller module, and encoding/decoding said digital data;
an internal memory coupled to said memory controller module, and temporarily storing decoded or encoded digital data;
a USB module coupled to said memory controller module, and controlling the receiving and transmitting of digital audio data from/to a USB port; and
a stereo ADC/DAC codec module coupled to said memory controller module, and receiving analog audio signals from an audio port and transforming said digital data into analog audio signals to transfer to said audio port.

2. The Bluetooth audio chip according to claim 1, further including a memory coupled to said memory controller module for storing said digital data.

3. The Bluetooth audio chip according to claim 2, wherein said memory is a flash memory.

4. The Bluetooth audio chip according to claim 2, wherein said digital data are digital audio data.

5. The Bluetooth audio chip according to claim 1, wherein said analog signals are analog audio data.

6. A Bluetooth audio chip, which is implemented in a monolithic circuit, comprising:
a memory controller module controlling the digital data transferring in said Bluetooth audio chip;
a Bluetooth RF (radio frequency) module receiving and transmitting Bluetooth audio packets;
a Bluetooth Baseband module coupled to said memory controller module and said Bluetooth RF module, said Bluetooth Baseband module reading the audio data from said memory controller module and transforming said audio data into Bluetooth audio packets to transfer to said Bluetooth RF module, or receiving said Bluetooth audio packets from said Bluetooth RF module and transforming said Bluetooth audio packets into said audio data to transfer to said memory controller module;
an encoder/decoder module coupled to said memory controller module, and encoding/decoding said audio data in said memory controller module;
an internal memory coupled to said memory controller module, and storing the Bluetooth audio data transferred from said memory controller module;
a UART module coupled to said memory controller module, and receiving audio data from a UART port, wherein said UART module transforms said audio data into said Bluetooth audio data to transfer to said memory controller module, or receiving said Bluetooth audio data from said memory controller module and transforming said Bluetooth audio data into said audio data to transfer to said UART port; and
a stereo ADC/DAC codec coupled to said memory controller module, and receiving analog signals from an audio port, wherein said stereo ADC/DAC codec transforms said analog signals into digital audio data to said memory controller module, or transforms said digital audio data into said analog signals from said memory controller module.

7. The Bluetooth audio chip according to claim 6, further including a memory coupled to said memory controller module for storing the digital data.

8. The Bluetooth audio chip according to claim 7, wherein said memory is a flash memory.

9. The Bluetooth audio chip according to claim 7, wherein said digital data are digital audio data.

10. A Bluetooth audio chip, which is implemented in a monolithic circuit, comprising:
a memory controller module controlling the digital data transferring in said Bluetooth audio chip;
a Bluetooth RF (radio frequency) module receiving and transmitting Bluetooth audio packets;
a Bluetooth Baseband module coupled to said memory controller module and said Bluetooth RF module, wherein said Bluetooth Baseband module reads the audio data from said memory controller module and transforms said audio data into Bluetooth audio packets to transfer to said Bluetooth RF module, or receives said Bluetooth audio packets from said Bluetooth RF module and transforms said Bluetooth audio packets into said audio data to transfer to said memory controller module;
an encoder/decoder module coupled to said memory controller module, and encoding said audio data in said memory controller module, or decoding said Bluetooth audio packets;
an internal memory coupled to said memory controller module, and storing said digital audio data transferred from said memory controller module;
a USB module coupled to said memory controller module, and controlling the receiving and transmitting of the digital audio data from/to a USB port;
a UART module coupled to said memory controller module, receiving and transmitting digital audio data from/to a UART port; and
a stereo ADC/DAC codec coupled to said memory controller module, and receiving analog signals from an audio port and transforming said analog signals into digital audio frequency data to transferred to said memory controller module, or transforming said digital audio frequency data into the analog audio sound from said memory controller module.

11. The Bluetooth audio chip according to claim 10, further including a memory coupled to said memory controller module for storing the digital data.

12. The Bluetooth audio chip according to claim 11, wherein said memory is a flash memory.

13. The Bluetooth audio chip according to claim 11, wherein said digital data are digital audio data.
